(19) United States
(12) Patent Application Publication
(10) Pub. No.: US 2001/0032554 A1
(43) Pub. Date: Oct. 25, 2001

(54) Processing center comprising a hot-stamping machine, hot-stamping machine and processing center comprising a special storage magazine for such a hot-stamping machine

(76) Inventors: Markus Fritz, Freudenstadt-Dietersweiler (DE); Kurt Kalmbach, Alpirsbach (DE); Johannes Schmid, Starzach-Wachendorf (DE)

Correspondence Address: Gary M. Nath, Nath & Associates PLLC, 6th Floor, 1030 15th Street, N.W., Washington, DC, 20005, US

(21) Appl. No.: 09/778,810

(22) Filed: Feb. 8, 2001

Related U.S. Application Data
(63) Continuation of application No. PCT/EP99/05852, filed on Aug. 12, 1999.

(30) Foreign Application Priority Data
Aug. 12, 1999 (DE) 198 36 566.7

(51) Int. Cl. B41D 7/00

(52) U.S. Cl. 101/33

(57) ABSTRACT

A processing center is disclosed that comprises at least one support capable of displacement in the X and Y axes, and preferably also in the Z axis, and at least one hot-stamping machine for applying a paint layer or a transfer layer, which is located on a support film, onto the surface of a workpiece and mainly onto the curved outline of a plate-shaped workpiece. The hot-stamping machine comprises an unwinding unit for unwinding the support film supporting the paint or transfer layer, a take-up unit for taking up the support film used, and at least one stamping cylinder which is rotationally mounted between the unwinding unit and the take-up unit and which can be applied onto the workpiece. The stamping cylinder is used for transferring the paint or transfer layer from the support film onto the workpiece.

### TECHNICAL FIELD

The invention relates to a processing or machining center including at least one support moveable in the X, Y and to advantage also in the Z direction for supporting a hot transfer finish assembly for applying a lacquer or transfer coating provided on a backing film to a workpiece surface area, more particularly to a curved workpiece contour of a sheet workpiece. The invention relates furthermore to one such hot transfer finish assembly specially devised to be interchangeable in a spindle unit of a machining unit, more particularly a machining center.

The invention relates furthermore to a machining center including a spindle unit moveable in the X, Y and Z direction for mounting tools and assemblies for machining wood or plastics or the like which is equipped with a special storage magazine for locating one or more hot transfer finish assemblies.

### PRIOR ART

In hot transfer finishing the work is done in general with a backing film on which a lacquer or transfer coating to be applied to the workpiece is provided. The backing film with the lacquer or transfer coating provided thereon is urged against the workpiece contour to be coated by a transfer drum. The combination of pressure and heat acting on the backing film causes the lacquer or transfer coating to be released from the backing film to tack on the workpiece, whereby it is to be noted that the backing film including the lacquer or transfer coating provided thereon is also termed transfer film or transfer finish film, i.e. prior to release of the lacquer or transfer coating the transfer finish film comprises the backing film and the transfer coating provided thereon.

Hot finishing such transfer films may be implemented either on the fly or stationary. When done on the fly, hot finishing can only be put to use on straight workpieces, whereas where workpieces having curved contours are concerned stationary machines are used.

Such stationary machines are bench devices requiring manual workpiece feed. To permit tracing the curved workpiece contour on these bench devices the workpieces need to be travelled past a rotatable, but fixed, transfer drum. In this arrangement the workpiece is urged manually or with the aid of an auxiliary means into contact with the transfer drum, i.e. the workpieces need to be guided past the transfer drum manually on bench devices. This is why these bench devices can be put to use only for relatively small workpieces to be coated, since larger parts are too difficult to handle. Apart from this the working speeds achievable with such stationary units is relatively low. This is why the thruput achievable with such units is unsatisfactory.

Known hot transfer finish bench devices work with rubber-surfaced transfer drums. This rubber surface is shaped negative to the contour of the workpiece so that the lacquer or transfer coating is transferred to the full surface area of the section or contour of the workpiece to be coated. These methods are suitable as a rule for working films up to approx. 40 mm thick.

In hot transfer finishing the film is heated by hot air or infrared radiation, system temperatures being in the region of approx. 160° C. to 180° C. After release of the lacquer or transfer coating (also termed dry lacquer coating) from the backing film the used backing film is taken up on a take-up device.

### SUMMARY OF THE INVENTION

The object forming the basis of the invention is to provide a device permitting machine-powered, more particularly fully automated hot transfer finishing of any workpiece contour. This object is achieved by a machining center having the features of claim 1 or by a hot transfer finish assembly having the features of claim 2.

The invention is furthermore based on the object of providing a machining center optimized for such a hot transfer finish assembly. This object is achieved by a machining center having the features of claim 21.

It is firstly to be noted that a hot-stamping machine in the sense of the invention is better known as a hot transfer finish assembly.

The gist of the invention is instead of moving the workpiece, as known in prior art, to maintain the workpiece stationary and to guide the means needed for hot transfer finishing along the contour to be coated or about the surface area of the workpiece. This now makes it possible to process also largish workpieces due to the novel idea of guiding the means for implementing hot transfer finishing about the workpiece. In addition, there is now no problem in automatically tracing any kind of curved contour. On top of this, several workpieces secured to a workbench can now be processed by a plurality of hot transfer finish assemblies each moveable separately.

For this purpose, in one aspect of the invention the hot transfer finish assembly is mounted interchangeable in a spindle unit of a machining center known as such and when installed can be moved along the workpiece contour program-controlled, thus making it possible for the first time to implement hot transfer finishing machine-powered and programmable irrespective of the workpiece contour.

For this purpose the interchangeable hot transfer finish assembly in the spindle unit of the machining center is equipped with a supply reel for holding and supplying a roll of film comprising the backing film with the lacquer or transfer coating provided thereon. Provided in addition is a take-up reel for taking-up the used backing film. Located between the supply reel and take-up reel is at least one rotatably mounted transfer drum on the hot transfer finish assembly for advancing into contact with the workpiece which transfers the lacquer or transfer coating from the transfer film to the workpiece.

With such a hot transfer finish assembly provided interchangeable in a spindle unit of a machining center it is now possible to trace any contour with the transfer drum optimally so that the traced contour is coated with the lacquer or transfer coating by pressure and more particularly heated in releasing the lacquer or transfer coating provided on the backing film, thus enabling several workpieces to be coated simultaneously at the outer contours by the hot transfer finishing method when the machining center has a multispindle design.

More particularly it is of advantage when a hot transfer finish assembly in accordance with the invention incorporates an internal heating means for heating the transfer drum from within and an external heating means for heating the transfer drum from without. Hitherto, on stationary bench units merely an external heating means was provided for heating the outer side of the transfer drum. Now, for the first time, an internal heating means is incorporated to advantage in accordance with the invention making it possible, where necessary, to reduce the temperature of the external heating means to minimize the risk of overheating the usually rubber-surfaced transfer drums and thus to enhance the useful life of such a transfer drum to advantage. This, of course, likewise extends the useful life of such a hot transfer finish assembly.

In a further advantagous embodiment the transfer drum is motor-powered to thus make for a more even heating of the transfer drum by the heating means due to the transfer drum being power-rotated during heating. This thus achieves with both the internal and external heating means a more even heating of the drum, especially by the external heating means since this due to its design can now be arranged to totally enclose the outer circumference of the transfer drum. In addition, since the transfer drum is motor-powered it can be continued to be rotated even when an emergency OFF is instigated, despite the heating still radiating, which could otherwise result in damage to the rubber surface of the transfer drum were it not rotating.

Advantageously the transfer drum is motor-powered with an over-running clutch interposed, thus making it possible that the speed with which the hot transfer finish assembly is advanced along the contour and with which the transfer drum circumscribes the contour is higher than the actual working speed of the transfer drum, or to put it more precisely, slip between the transfer drum and the workpiece contour contacting the transfer drum is avoided.

Heating up the transfer drum internally to the working temperature very evenly is possible in that the transfer drum is configured hollow with the internal heating means being located in this hollow space. Advantageously the internal heating means is configured so that the complete wall of the hollow space of the transfer drum is evenly heated, this being possible, for example, with an infrared radiant heater means, but also, however, with a hot-air heating means.

By arranging a temperature sensor in the hollow space of the transfer drum which is connected to a temperature regulator of the internal and/or external heating means, a controlled warm up of the transfer drum to the necessary working tem perature is possible. This thus practically avoids risking damage to the transfer drum, especially of the more sensitive rubber surface, to advantage.

As already mentioned it is good practice when the transfer drum is power-rotated during warmup to achieve a more even heating of the transfer drum whilst preventing hot spots from materializing. A highly flexible configuration optimized for individual applications is achieved by mounting the transfer drum replaceable in the hot transfer finish assembly, thus making it possible to employ a special outer contour adapted to the workpiece contour in each case. A hot transfer finish assembly can then be put to use for a wide variety of workpiece contours to be coated.

Optimally the transfer drum is mounted shiftable in the hot transfer finish assembly, thus making it possible that the backing film is not in contact with the transfer drum in a waiting position and that the backing film runs around the transfer drum in a working position. This ensures that the backing film is not overheated in a waiting position and that the transfer drum presses the backing film with the lacquer or transfer coating provided thereon against the workpiece surface area only in being travelled along the workpiece surface area to be coated. One technically uncomplicated and cost-effective solution consists of the transfer drum being power shiftable from the waiting position into the working position and vice-versa.

Since the take-up unit is motor-powered the tension of the backing film can be controlled, it in addition being possible to take up used backing film with no problem. Optimally the take-up unit is motor-powered via the spindle unit of the machining center. This eliminates the need for a separate drive for the take-up unit. Thus, optimal use is made of the drive already provided in the machining center, i.e. the spindle unit.

For certain workpiece contours it is necessary to vary the speed with which the backing film with the lacquer or transfer coating provided thereon is supplied from the reel. For this purpose a braking means is optimally provided in the hot transfer finish assembly with which the supply speed of the backing film with the lacquer or transfer coating provided thereon can be adjusted. More particularly it is good practice in this respect to provide the braking means immediately downstream of the supply reel so that the supply speed is optimally adjustable by the braking means and the motor-powered drive of the take-up reel.

Providing a, more particularly, adjustable slip clutch in the hot transfer finish assembly acting between the take-up reel and the spindle unit of the machining center prevents any risk of the hot transfer finish assembly being overloaded and thus damaged when the system blocks due to faulty travelling along the workpiece contour.

Optimally the interchangeable hot transfer finish assembly comprises an interface matching a spindle unit as it reads from EP 96 107 595, i.e. the interface of the hot transfer finish assembly essentially corresponds to the interfaces of other interchangeable assemblies in the spindle unit of the machining center; with the restriction, of course, that only the supply means needed for the hot transfer finish assembly are provided. A hot transfer finish assembly is accordingly compatible with a machining center or the special spindle unit as described in the cited patent application.

Due to a hot transfer finish assembly of the aforementioned kind being configured interchangeable in a spindle unit, more particularly with an interface compatible with the spindle unit as it reads from EP 96 107 595 one such hot transfer finish assembly can also be interchanged in a spindle unit of a specially designed machine for optimal operation on the fly. This means that a spindle unit is integrated substantially stationary in such a machine for machining the edges of a workpiece and the corresponding hot transfer finish assembly for coating the machined workpiece edges can be mounted thereon. This thus provides, for the first time, an assembly which can be put to use both stationary and moving, thus expanding the range of application of an interchangeable hot transfer finish assembly.

An embodiment is also conceivable in which a joint is provided in the hot transfer finish assembly permitting swivelling of the complete hot transfer finish assembly relative to a support serving insertion in the spindle unit of the machining center. Optimally this swivelling of the hot transfer finish assembly about the joint can be implemented by means of an electric motor to thus make it possible, for instance, to coat both vertical and horizontal surface areas with the lacquer or transfer coating in hot transfer finishing. In addition to this, this would also make inclined surface areas coatable by means of a special embodiment of a hot transfer finish assembly in accordance with the invention.

A machining center as is widely known in the present technical field for use with a hot transfer finish assembly is optimally equipped with a storage magazine (crib) for storing one or more hot transfer finish assemblies of the aforementioned kind into which or from which a hot transfer finish assembly can be inserted or removed by means of the spindle unit of the machining center. Provided in addition in the storage magazine is a power connection with which the heating means of a hot transfer finish assembly held in the storage magazine can be operated. Thus the operating temperatures needed for instant use of these assemblies are achieved shortly before receival of a stored hot transfer finish assembly.

### BRIEF DESCRIPTION OF THE DRAWINGS

An example embodiment of the invention will now be detailed for a better understanding with reference to the attached drawings, in which

FIG. 1 is a diagrammatic plan view of a hot transfer finish assembly in accordance with the invention provided interchangeable in a spindle unit of a machining center,

FIG. 2 is a diagrammatic representation of various drives in a hot transfer finish assembly as shown in FIG. 1 and

FIG. 3 is a diagrammatic representation of a hot transfer finishing operation in various steps in the method in tracing a contour with a hot transfer finish assembly in accordance with the invention.

### DESCRIPTION OF A PREFERRED EMBODIMENT

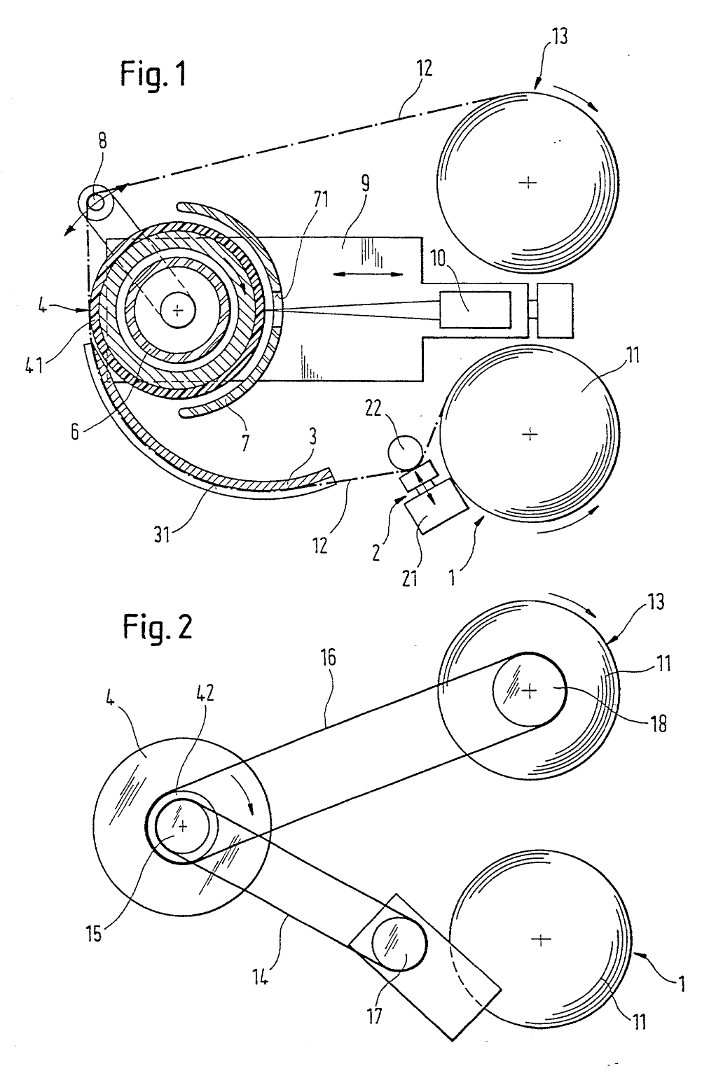

Referring now to FIG. 1 there is illustrated a diagrammatic plan view of the individual components and their relation to each other of a hot transfer finish assembly in accordance with the invention. A supply reel 1 comprises a non-powered film plate serving to mount the roll of film 11 which in this case com prises a reeled backing film 12 with the lacquer or transfer coating provided thereon to be applied to a workpiece contour.

Provided downstream of the supply reel 1 is a braking means 2 comprising a deflector pulley 22 and opposite the deflector pulley 22 an air or motor actuated shiftable brake block 21. Guided between the deflector pulley 22 and the brake block 21 is the backing film 12 with the lacquer or transfer coating provided thereon.

The braking means 2 is followed by a film guide 3 comprising a curved outer surface area 31 along which the backing film 12 with the lacquer or transfer coating provided thereon glides in being advanced to a transfer drum 4. It is to be noted in this respect that the lacquer or transfer coating is provided of course on the side of the backing film which does not slide along the surface area 31. The curved film guide 3 ends at the outer shell 41, in this case a rubber surface of the transfer drum 4. The transfer drum 4 is rotatively mounted and motor-powered by means of a motor 17 as will be detailed later on with reference to FIG. 2.

The transfer drum 4 is configured as a hollow cylinder and on the outer side, as already mentioned, provided with a rubberized outer shell 41 shaped to conform with the workpiece contour for contact therewith. Arranged in the hollow space of the transfer drum 4 is an internal heating means 6 irradiating the inner wall of the hollow space of the transfer drum 4 on all sides to heat the transfer drum 4 from within.

As evident from FIG. 1 the transfer drum 4 is surrounded on the outside over part of the circumference by an external heating means 7 with which the outer shell 41 is heatable. Provided in this external heating means 7 is a opening 71 through which the temperature sensor is passed and which measures the surface temperature of the outer shell 41 of the transfer drum 4 and signals the temperature to a measuring system 10 so that the external heating means 7 and/or the internal heating means 6 can be regulated in accordance with the requirements in each case.

Swivably mounted about the axis of rotation of the transfer drum 4 is a swivel bracket 8 on which a deflector pulley is rotatively mounted to deflect the used backing film 12 and guide it to a downstream take-up reel 13. The take-up reel 13 comprises a motor-powered reel for taking up the used backing film 12.

Referring now to FIG. 2 there is illustrated a diagrammatic plan view for a better overview of the individual drives of a hot transfer finish assembly in accordance with the invention as described above. A motor 17 incorporated in the hot transfer finish assembly drives the transfer drum 4 via a belt drive 14. An overrunning clutch 15 is interposed permitting a faster rotation of the transfer drum 4 than as dictated by the motor 17. Via the spindle 42 the take-up reel 18 is motor-powered by means of a belt drive 16, it being understood, of course that by correspondingly configuring the belt drives 14 and 16 the rotary speed needed in each case of the individual components is defined; for example by the number of teeth of individual gearwheels.

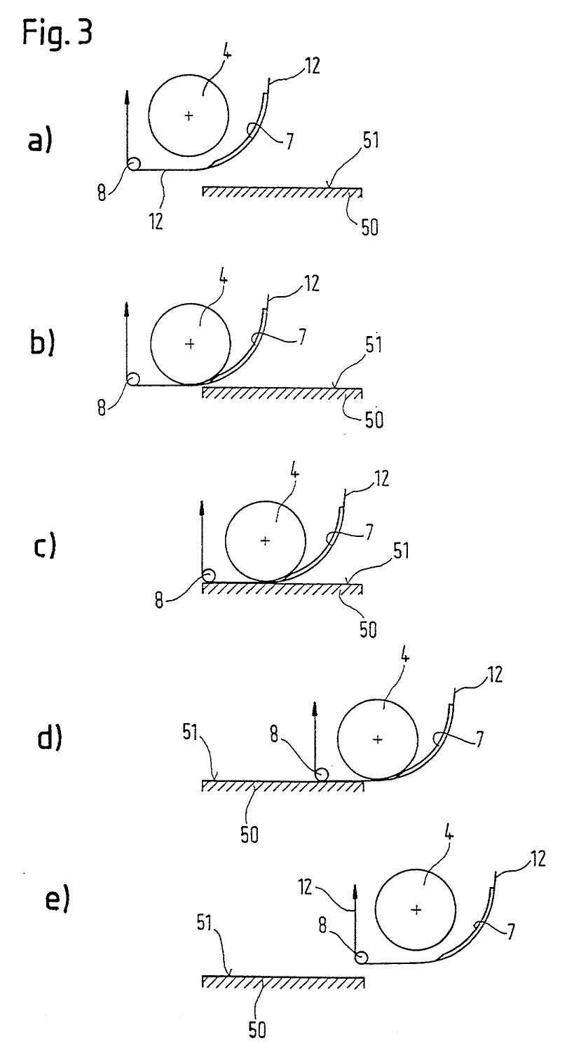

Referring now to FIG. 3 there is illustrated the steps in hot transfer finishing with the hot transfer finish assembly in accordance with the invention. In step a) the transfer drum 4 is retracted in a waiting position, i.e. the slide 9 is retracted as compared to the illustration in FIG. 1. By means of the heating means 6 and 7 the transfer drum 4 is heated to the working temperature, the transfer drum 4 thereby being rotated via the motor 17 and belt drive 14.

As soon as the working temperature of the transfer drum 4 is attained, then in step b) the hot transfer finish assembly is advanced to the workpiece contour 51 of the workpiece 50 to be coated and the slide 9 extended so that the transfer drum 4 contacts the inner side of the backing film 12, urging it against the contour 51.

In travelling the hot transfer finish assembly along the contour 51 of the workpiece 50 then in steps c) and d) the pressure exerted by means of the transfer drum 4 on the backing film 12 transfers the lacquer or transfer coating provided thereon onto the contour 51 and the used backing film is taken up by the take-up reel 13. In applying the lacquer or transfer coating to the workpiece contour 51 the swivel bracket 8 serves with the deflector pulley as the release point for the lacquer or transfer coating provided on the backing film 12, i.e. as shown in c) of FIG. 3 the lacquer or transfer coating tacks by means of the transfer drum 4 up to the swivel bracket 8 on both the backing film 12 and on the workpiece contour 51 and is not released until guided about the swivel bracket 8. By suitably travelling the hot transfer finish assembly the transfer drum 4 can thus be travelled along substantially any contour. The traceable contour in this respect is substantially defined by the outer diameter of the transfer drum 4.

Once the workpiece has been fully coated then in step e) as shown in FIG. 3 the hot transfer finish assembly is retracted from the workpiece contour 51 and at the same time the transfer drum 4 retracted from the backing film 12 by means of the slide 9. In this arrangement the transfer drum 4 continues to rotate to avoid overheating of the roll, more particularly by the heating means 7 but also by the heating means 6.

As soon as the end of the contour is reached the transfer drum 4 is lifted off. The hot transfer finish assembly continues to be travelled, however, until the swivel bracket 8 too has passed the contour, after which the take-up reel 13 is also halted.

To permit further machining by the machining center the hot transfer finish assembly can be deposited in the storage magazine (not shown) and, if necessary, maintained at working temperature or waiting temperature. In the first case, the drive of the transfer drum 4 then also needs to be assured, of course, to advantage by the motor 17.

1. A machining center including at least one support moveable in the X, Y and to advantage also in the Z direction for supporting a hot transfer finish assembly for applying a lacquer or transfer coating provided on a backing film (12) to a workpiece surface area (51), more particularly to a curved workpiece contour of a sheet workpiece (50) which can be travelled along said workpiece surface area (51) to be coated and comprising:
a supply reel (1) for supplying a backing film (12) with said lacquer or t transfer coating provided thereon,
a take-up reel (13) for taking up the used backing film and
at least one transfer drum (4) rotatively mounted between said supply reel (1) and said take-up reel (13) for application to said workpiece with which said lacquer or transfer coating can be transferred from said backing film (12) to said workpiece (50).

2. A hot transfer finish assembly for applying a lacquer or transfer coating provided on a backing film (12) to a workpiece surface area (51), more particularly a curved workpiece contour of a sheet workpiece (50), said hot transfer finish assembly being mounted interchangeable in a spindle unit (15) of a machining unit, more particularly a machining center, comprising:
a supply reel (1) for supplying a backing film (12) with said lacquer or transfer coating provided thereon,
a take-up reel (13) for taking up the used backing film and
at least one transfer drum (4) rotatively mounted between said supply reel (1) and said take-up reel (13) for application to said workpiece with which said lacquer or transfer coating can be transferred from said backing film (12) to said workpiece (50).

3. The hot transfer finish assembly as set forth in claim 1 or 2, characterized in that an internal heating means (6) for heating said transfer drum (4) from within and an external heating means (7) for heating said transfer drum (4) from without are provided.

4. The hot transfer finish assembly as set forth in claim 1 or 2, characterized in that said transfer drum (4) is motor-powered.

5. The hot transfer finish assembly as set forth in claim 4, characterized in that said transfer drum (4) is coupled to said motor drive (17) with an overrunning clutch (15) interposed.

6. The hot transfer finish assembly as set forth in any of the preceding claims, characterized in that said transfer drum (4) is configured hollow and said internal heating means (6) is arranged in said hollow space.

7. The hot transfer finish assembly as set forth in claim 6, characterized in that in said hollow space of said transfer drum a temperature sensor is connected to a temperature regulator of said inner (6) and/or said external heating means (7).

8. The hot transfer finish assembly as set forth in claim 3, characterized in that in the region of the outer circumference of said transfer drum (4) a temperature sensor is applied which is connected to said external heating means (7).

9. The hot transfer finish assembly as set forth in any of the claims 4-8, characterized in that said transfer drum (4) is rotated by means of said motor drive (17) during heating up.

10. The hot transfer finish assembly as set forth in claim 1 or 2, characterized in that said transfer drum (4) has a rubber surface and said backing film (12) runs around said rubber surface.

11. The hot transfer finish assembly as set forth in any of the preceding claims, characterized in that said transfer drum (4) is mounted replaceable in said hot transfer finish assembly and a transfer drum (4) having an outer contour adapted to said workpiece contour is applicable each time.

12. The hot transfer finish assembly as set forth in claim 1 or 2, characterized in that said transfer drum (4) is shiftingly mounted in said hot transfer finish assembly so that in a waiting position said backing film (12) is not in contact with said transfer drum (4) and in a working position said backing film (12) runs around in contact with said transfer drum (4).

13. The hot transfer finish assembly as set forth in claim 11, characterized in that said transfer drum (4) is power shiftable by an electric motor or pneumatically from said waiting position into said working position and vice-versa.

14. The hot transfer finish assembly as set forth in claim 1 or 2, characterized in that said take-up reel (13) is motor-powered.

15. The hot transfer finish assembly as set forth in any of the claims 1, 2 or 13, characterized in that said take-up reel (13) is driveable via said spindle unit (42) of said machining center.

16. The hot transfer finish assembly as set forth in claim 1 or 2, characterized in that a braking means (2) is provided with which the supply speed of said backing film (12) with said lacquer or transfer coating provided thereon is adjustable from said supply reel (1).

17. The hot transfer finish assembly as set forth in claim 1 or 2, characterized in that a more particularly adjustable slip clutch (18) is provided acting between said take-up reel (13) and said spindle unit (15) of said machining center.

18. The hot transfer finish assembly as set forth in claim 1 or 2, characterized in that a joint is provided permitting swivelling of said complete hot transfer finish assembly relative to a support serving for insertion into said spindle unit (42) of said machining center.

19. The hot transfer finish assembly as set forth in claim 18 wherein a motor for swivelling said hot transfer finish assembly is provided.

20. The hot transfer finish assembly as set forth in claim 2, characterized in that the interface of said hot transfer finish assembly is configured so that it is interchangeable in a spindle unit as it reads from EP 96 107 595.9.

21. A machining center including a spindle unit moveable in the X, Y and Z direction for mounting tools and assemblies for machining wood or plastics or the like comprising
